(19) United States
(12) Patent Application Publication
(10) Pub. No.: US 2023/0214725 A1
(43) Pub. Date: Jul. 6, 2023

(54) METHOD AND APPARATUS FOR MULTIPLE REINFORCEMENT LEARNING AGENTS IN A SHARED ENVIRONMENT

(71) Applicant: HUAWEI CLOUD COMPUTING TECHNOLOGIES CO., LTD., Gui Zhou Province (CN)

(72) Inventors: Zhenhua HU, Toronto (CA); Timothy James ZEYL, Toronto (CA); Salma Shukry Hussien Mohamed EMARA, Toronto (CA); Baochun LI, North York (CA); Fei WANG, Toronto (CA)

(73) Assignee: HUAWEI CLOUD COMPUTING TECHNOLOGIES CO., LTD., Gui Zhou Province (CN)

(21) Appl. No.: 17/566,953

(22) Filed: Dec. 31, 2021

(51) Int. Cl. G06N 20/20

(52) U.S. Cl. CPC G06N 20/20

(57) ABSTRACT

There is provided methods and apparatuses for training multiple reinforcement learning agents without requiring inter-agent or agent-server communication in multi-agent reinforcement learning applications where fairness between the agents is desired. According to embodiments, fairness between multiple deep reinforcement learning agents in the same environment can be achieved while not requiring inter-agent communication. The method includes creating episodes where two or more RL agents are deployed in a shared environment, each RL agent behaving independently according to its own policy without inter-agent communication. The method further includes storing the RL agent's experiences in a shared experience replay buffer that exists across multiple training episodes, the shared experience replay buffer being shared between the RL agents. In addition, the method includes drawing from the shared experience replay buffer to update a global policy after each episode and setting the global policy to be subsequently used by all RL agents.

### CROSS-REFERENCE TO RELATED APPLICATIONS

This is the first application filed for the present disclosure.

### FIELD

The present disclosure pertains to the field of machine learning and in particular to a method and apparatus for multiple reinforcement learning agents in a shared environment.

### BACKGROUND

Reinforcement learning (RL) is a type of machine learning that provides systems and applications with the ability to learn and automatically improve through experience and by the use of data. In RL, there exist intelligent agents which take actions based on an observed state. Each intelligent agent acts and directs its activities towards achieving a specific set of goals. The RL agent's action selection is modeled as a policy. In deep reinforcement learning (DRL), the policy is a multi-layered neural network having input that is the observed state and the output is utilized for selection of the agent's action.

In RL, an agent interacts with various environments by successively observing a state and taking an action according to its current policy. The agent also interacts with environments either by receiving an immediate reward for its action or by continuing to adhere to its current policy and after successive states and actions, receiving a delayed reward. The reward, based on its magnitude and sign, can be used to train an agent's policy. For example, actions triggering large rewards will more likely be performed in the future and actions triggering small rewards or a penalty will less likely be taken.

In multi-agent reinforcement learning (MARL), there can be multiple agents interacting with the same environment. In MARL, actions taken by one agent can affect the state observed by another agent. As such, although each agent takes its action individually, there is one or more global goals shared among the agents. The global goals can require some optimization and a certain level of fairness between the agents.

In order to achieve the global goals shared among the agents, the individual agents share their observed states or hidden representation thereof. For this, the agents need to communicate either with each other or with a central entity (for example, a central server) which in turn influences actions of at least one agent in the same environment.

However, such requirements of inter-agent or agent-server communication to achieve a global goal and fairness in sharing, prohibits the use of traditional MARL at least in some circumstances. For example, in network congestion control, inter-agent communication between agents can make the use of traditional MARL undesirable or even prohibited for a number of reasons including overhead communication resulting in delayed decision making of each agent.

Therefore there is a need for a method and apparatus for training multiple reinforcement learning agents, that is not subject to one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a method and apparatus for multiple reinforcement learning agents in a shared environment. In accordance with embodiments of the present disclosure, there is provided a method for training multiple reinforcement learning (RL) agents deployed in a shared environment. During an episode including one or more steps and associated with the shared environment, each of the multiple RL agents behaving based at least in part on a global policy throughout the episode, the method includes creating, by each of the multiple RL agents, experience tuples, each experience tuple created at the end of each step. The method further includes storing, by each of the multiple RL agents, the experience tuples in a shared experience replay buffer, the shared experience replay buffer shared by the multiple RL agents throughout the episode and a next episode. After the episode the method further includes updating the global policy based on sampled experience tuples drawn from the shared experience replay buffer and distributing the updated global policy to the multiple RL agents, wherein each of the multiple RL agents behave based at least in part on the updated global policy in the next episode.

In some embodiments, updating and distributing are performed by one of the multiple RL agents.

In some embodiments, each experience tuple includes a state of the shared environment at the beginning of each step, an action taken during each step, a state of the shared environment at the end of each step and a reward obtained at the end of each step.

In some embodiments, the global policy is updated in a form of gradient descent such that an adjustment is made to one or more parameters of the global policy based at least in part on gradients of a loss function with respect to each of the one or more parameters.

In some embodiments, the shared experience buffer is a prioritized experience replay buffer. In some embodiments, the sampled experience tuples are drawn from the shared experience replay buffer based on unexpectedness of each experience tuple stored in the shared experience buffer, the unexpectedness of each experience tuple determined based on the global policy prior to updating. In some embodiments, the multiple RL agents are trained using a multi-staged process, the multi-staged process progressing in difficulty from stage to stage, each stage adding a challenging characteristic associated with the shared environment.

In some embodiments, the multiple RL agents are trained using a multi-staged process, the multi-staged process progressing in difficulty from stage to stage, each stage adding a challenging characteristic associated with the shared environment. In some embodiments, the shared experience replay buffer is divided into multiple segments, each segment associated with each stage of the multi-staged process. In some embodiments, the multi-staged process includes a bootstrapping stage, an advancing stage, a fairness training stage. In some embodiments, the multi-staged process further includes an online stage.

In some embodiments, the multiple RL agents are deployed online and the updated global policy is distributed to the multiple RL agents at arbitrary intervals.

In accordance with embodiments of the present disclosure, there is provided a system for training multiple reinforcement learning (RL) agents deployed in a shared environment. During an episode including one or more steps and associated with the shared environment, each of the multiple RL agents behave based at least in part on a global policy throughout the episode. The system includes a data collection unit associated with the multiple RL agents, the data collection unit having a processor and a memory storing instructions. The instructions when executed by the processor configure the data collection unit to receive from each of the multiple RL agents, experience tuples, each experience tuple created at the end of each step and store the experience tuples in a shared experience replay buffer, the shared experience replay buffer shared by the multiple RL agents throughout the episode and a next episode. The system further including a training unit associated with the multiple RL agents, the training unit having a processor and a memory storing instructions. The instructions when executed by the processor configure the training unit, after each episode, to update the global policy based on sampled experience tuples drawn from the shared experience replay buffer and distribute the updated global policy to the multiple RL agents. Each of the multiple RL agents behave based at least in part on the updated global policy in the next episode.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates interaction between an agent and an environment in a reinforcement learning (RL) scenario.

FIG. 2 illustrates a method of training multiple RL agents that share the same environment, in accordance with embodiments of the present disclosure.

FIG. 3 illustrates a shared experience replay buffer configured as a prioritized experience replay buffer, in accordance with embodiments of the present disclosure.

FIG. 4 illustrates multiple RL agents interacting in a shared network congestion control environment, in accordance with embodiments of the present disclosure.

FIG. 5 illustrates a method of training multiple RL agents that are deployed, in accordance with embodiments of the present disclosure.

FIG. 6 illustrates an implementation of the multi-staged process of training RL agents for network congestion control, in accordance with embodiments of the present disclosure.

FIG. 7 illustrates segmentation of a prioritized experience replay buffer for an offline learning stage and an online learning stage, in accordance with embodiments of the present disclosure.

FIG. 8 a method for training multiple reinforcement learning agents, in accordance with embodiments of the present disclosure.

FIG. 9 is a schematic structural diagram of a system architecture according to an embodiment of the present disclosure.

FIG. 10 is a structural hardware diagram of a chip according to an embodiment of the present disclosure.

FIG. 11 illustrates a schematic diagram of a hardware structure of a training apparatus according to an embodiment of the present disclosure.

FIG. 12 illustrates a schematic diagram of a hardware structure of an execution apparatus according to an embodiment of the present disclosure.

FIG. 13 illustrates a system architecture according to an embodiment of the present disclosure.

FIG. 14 is a schematic structural diagram of a recurrent neural network (RNN) according to embodiments of the present disclosure.

It will be noted that throughout the appended drawings, like features are identified by like reference numerals.

### DETAILED DESCRIPTION

### Definitions

In the present disclosure, the term ‘episode’ refers to all state-action-reward sequences between an initial state and a terminal state. Each episode includes a pre-specified number of steps. In each step, each RL agent observes a state, takes an action, and obtains a reward.

The present disclosure provides a method and apparatus for training multiple reinforcement learning (RL) agents without requiring inter-agent or agent-server communication in multi-agent reinforcement learning (MARL) applications where fairness between the agents is desired. According to embodiments, fairness between multiple deep reinforcement learning (DRL) agents in the same environment (for example, a shared environment) can be achieved while not requiring inter-agent communication. The method for training RL agents includes creating episodes where two or more RL agents are deployed in a shared environment, each RL agent behaving independently according to its own policy without inter-agent communication. The method further includes storing the RL agent's experiences (for example, state-action-reward sequences) in an experience buffer that exists across multiple training episodes (for example, episodes of training), the experience buffer being shared between the RL agents and thus can be defined as a shared experience replay buffer. In addition, the method includes drawing from the shared experience replay buffer to update a global policy after each episode and setting the global policy to be used by all RL agents in the next training episode to the global policy.

According to embodiments, the fairness between the RL agents is achieved by allowing multiple RL agents to interact in the shared environment and recording their experiences (for example, state-action-reward tuples) in a shared experience replay buffer. The shared experience replay buffer is utilized to train a single global unified policy to which each agent adheres when each RL agent interacts in the environment. During deployment, the trained policy (for example, the single global unified policy) can be used without needing to record further experiences. Therefore, communication between the RL agents is not required. Also, the fairness between the RL agents can be achieved by virtue of the shared environment and the training associated with a single global unified policy.

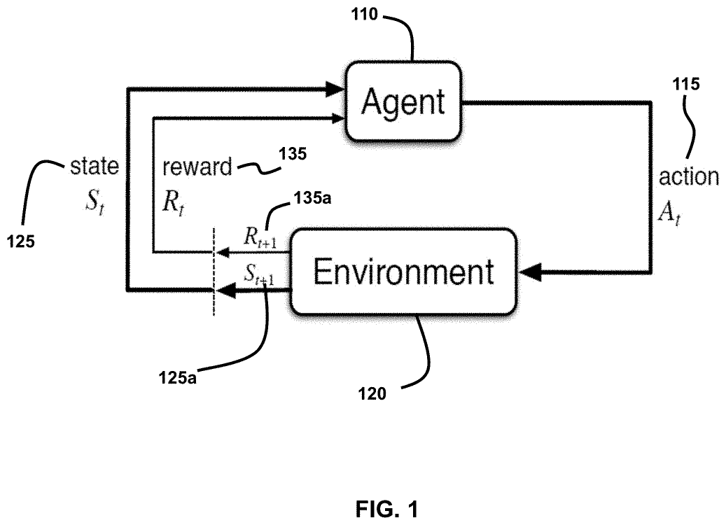

FIG. 1 illustrates an interaction between an agent and an environment in a reinforcement learning (RL) scenario. Referring to FIG. 1, the agent 110 is a decision maker and learner, and the environment 120 includes the features that are outside of the agent 110. The agent 110 interacts with the environment 120 in discrete time steps. The agent 110 selects an action in the environment 120. The environment 120 responds to these actions, and presents a new state (for example, a new situation) to the agent 110. At each time step, the agent 110 receives a current state 125 and a reward signal 135. Throughout the interaction 115, the agent 110 seeks to learn the best behavior or policy to maximize the reward signal 135, for example maximizing the reward signal over time.

Specifically at each discrete time t, the agent 110 observes the state Sₜ 125 and reward Rₜ 135. The state Sₜ 125 is indicative of the environment 120 related to the goals of the agent 110. The agent 110 then exerts an action Aₜ 115 by interacting with the environment 120. Through the interaction with the agent 110, the environment 120 changes, and therefore the new state Sₜ₊₁ 125a and the reward Rₜ₊₁ 135a are obtained.

As stated above, in MARL, actions taken by one agent can affect the state observed by other agents. As such, although each agent takes its respective action individually, there is one or more global goals shared among the RL agents. The global goals can require optimization and a certain level of fairness between the agents. How the fairness between the RL agents may be achieved is defined elsewhere in the present disclosure.

An example MARL environment can be found in association with computer system network congestion control. In a computer system network, a flow is a stream of data packets, which is a unit of bytes, transmitted from an application (for example, sending application) on one device to another application (for example, receiving application) on another device. Multiple flows may exist simultaneously on a network link between two devices. RL can be used to train the policy associated with each flow in order that for each flow, the sending application can control the sending rate of data packets across the network link. The shared goal among all RL agents on the network link can be associated with a high throughput, low latency and loss rate and fair sharing of the network link bandwidth.

In order to achieve the global goals shared among the agents using the existing technologies, each of the agents need to communicate either with each other or with a central entity (for example, a central server) which in turn influences actions of some agents in the same environment. Such a requirement of inter-agent or agent-server communication to achieve a global goal and fairness in sharing can prohibit the use of traditional MARL at least in some circumstances. For example, in network congestion control where multiple RL agents control the sending rate of each flow, the inter-agent communication requirement can make the use of traditional MARL undesirable or even prohibitive for a number of reasons including delay in the decision making process of each agent. For instance, the decision making process of each agent can be delayed due to processes of sending states to other agents and receiving states from other agents (for example, including waiting time). Moreover, due to the dynamic nature of flow, it can be even more challenging to track the number of flows that are originating on a single device and that are sharing a link. When the flows originating on multiple devices share the same link, the inter-agent communication also needs to take place on that link, thereby reducing the available bandwidth associated with that particular link. Furthermore, when flows share only part of a link, it can be difficult to determine the number of flows sharing components associated with the link.

The use of experience replay buffers has been discussed in multi-agent settings and in multi-staged curriculum learning where tasks progress from a stage with a single agent to a stage with multiple agents. For example, this is at least in part discussed in “From few to more: Large-scale dynamic multiagent curriculum learning”; Association for the Advancement of Artificial Intelligence (AAAI); pages 7293-7300, 2020; Weixun Wang, Tianpei Yang, Yong Liu, Jianye Hao, Xiaotian Hao, Yujing Hu, Yingfeng Chen, Changjie Fan, and Yang Gao, hereinafter referred to as “R1”, and “Cm3: Cooperative multi-goal multi-stage multi-agent reinforcement learning”; International Conference on Learning Representations (ICLR); 2020; by Jiachen Yang, Alireza Nakhaei, David Isele, Kikuo Fujimura, and Hongyuan Zha, hereinafter referred to as “R2”. However, the disclosure of both R1 and R2, define that communication between the agents is required. As such, it has been realized that a multi-staged approach and use of staged-replay buffers without requiring inter-agent communication (for example, MARL agents do not need to communicate with each other) are desired.

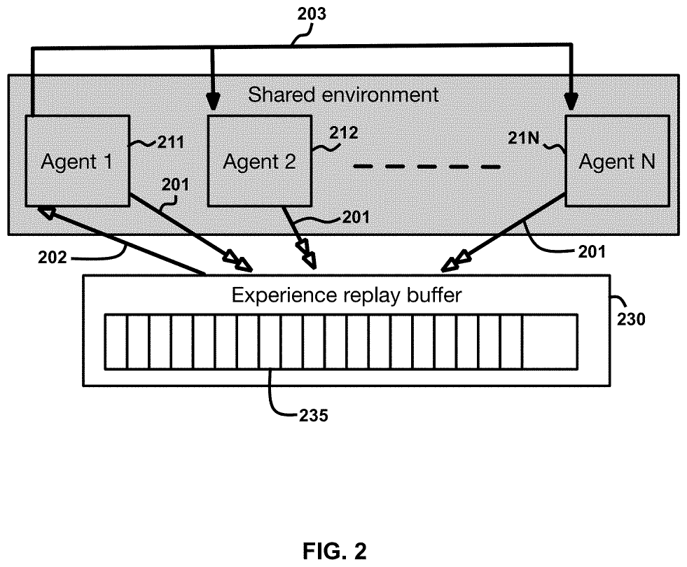

FIG. 2 illustrates a process of training multiple RL agents that share the same environment, in accordance with embodiments of the present disclosure. Referring to FIG. 2, each of the RL agents 211, 212, . . . , 21N interacts with the shared environment 220. As such, actions of each RL agent affect the observations of the other agents associated with the shared environment. For instance, actions of agent 211 affect the observations of the agents 212, . . . , 21N.

According to embodiments, at each step of an episode, each agent 211, 212, . . . , 21N observes a state, takes an action, and observes a reward, wherein these pieces of information may be configured as an experience tuple. One or more new agents may be added or one or more of the agents 211, 212, . . . , 21N may be removed at any step in the episode, and each agent 211, 212, . . . , 21N uses the same global policy throughout a single episode. At the end of the step of an episode, each agent 211, 212, . . . , 21N creates a state-action-reward-next state experience tuple 235. The experience tuple 235 includes i) the state at the beginning of the step, ii) the action taken during the step, iii) the state of the neural network at the end of the step and iv) the reward obtained at the end of the step.

The experience tuple 235 of each agent 201 is saved in a shared experience replay buffer 230. The shared experience replay buffer 230 is a block of memory that stores the experience tuples 235. After each episode, the global policy is updated. A single agent (for example, agent 211) may be used to update the policy whereby that agent (for example, agent 211) takes 202 samples of a batch of experience tuples 235, in order to update the policy. In some embodiments, the policy may be represented by a neural network.

The updating of the policy or policy update may take place in a form of gradient descent, where a small adjustment to the parameters of the policy, which for example may be represented as a neural network, is made. The direction and magnitude of the small adjustment can be determined by the gradients of a loss function with respect to each parameter. The loss function can be defined using the rewards observed in the batch of experience tuples 235 sampled 202 from the shared experience replay buffer 230, wherein the loss function can be represented as the difference between a desired target and a current target is minimized. It is understood that the term target can be represented in terms of rewards observed. After the global model, or global policy, is updated, the updated global model is shared 203 with other agents (for example, agents 212, . . . , 21N) in the same shared environment 220 at the next episode of training.

According to some embodiments, the shared experience replay buffer (for example, shared experience replay buffer 230) can be a prioritized experience replay buffer. For reference, a prioritized replay buffer is at least in part discussed, for example in “Prioritized experience replay, in Proc. 4th International Conference on Learning Representations (ICLR), 2016” by T. Schaul, J. Quan, I. Antonoglou, and D. Silver, hereinafter referred to as R3.

According to embodiments, the shared experience replay buffer, for example which may be configured as a prioritized experience replay buffer, can be used to provide tuple samples to train the model, represented by a policy, for example the global policy, may not be sufficiently trained, as those experience tuple samples may be unexpected based on the current global policy. Put another way, there may exist discrepancies between the output expected by a current policy (for example a current global policy) and the output of the experience tuple. For example, when an action taken at a particular step results in a certain observed state in the experience tuple, this observed state may be completely different from the observed state expected based the current global policy.

According to embodiments, the more unexpected tuples that are sampled for this training or updating of the global policy, the faster the model (for example, representative of the global policy) can converge to an optimal behavior. In order to utilize more unexpected samples, each experience tuple sample in the experience replay buffer is characterized in terms of a sampling probability based on its unexpectedness. The sampling probability is proportional to the unexpectedness of the experience tuple sample. In this way, more unexpected tuples can be sampled when a batch of experience tuples are sampled, for example in the next episode.

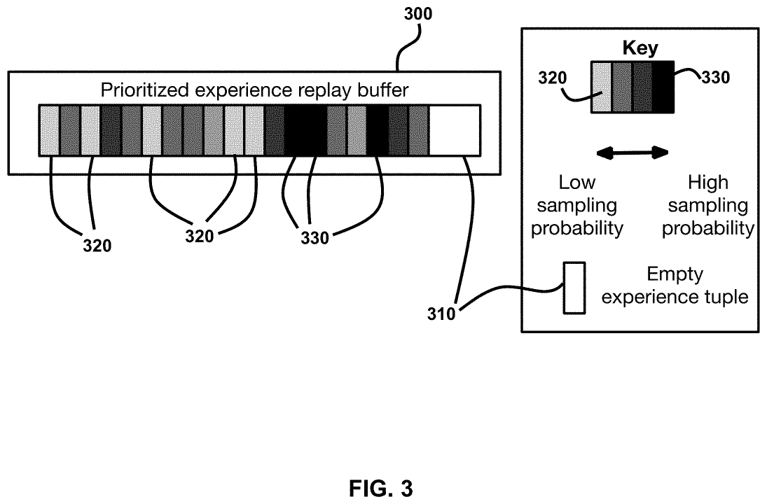

FIG. 3 illustrates an example of a prioritized experience replay buffer 300, in accordance with embodiments of the present disclosure. Referring to FIG. 3, provided that each rectangle of the prioritized experience replay buffer 300 represents an experience tuple, the prioritized experience replay buffer 300 includes a number of experience tuple samples with various sampling probabilities. In FIG. 3, the shade of each experience tuple represents the sampling probability. Specifically, the darker the shade of the experience tuple, the higher the sampling probability. For example, with reference to FIG. 3, the white shaded experience tuple, such as the experience tuple 310, is indicative of an empty experience tuple. The light gray shaded experience tuples, such as the experience tuples 320, have a low sampling probability and the black gray (or dark gray) shaded experience tuples, such as the experience tuples 330, have high sampling probability. It should be noted that the more recent experience tuple samples are the more unexpected experience tuple samples, as the newer experience tuple samples are used for training of the model (for example the global policy) less than the older experience tuple samples in the experience replay buffer 300.

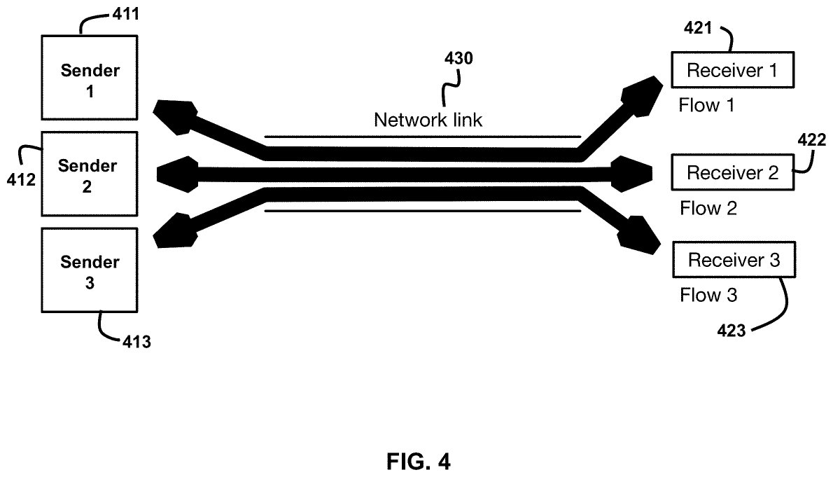

According to embodiments, multiple RL agents can be trained where the shared environment is a network link and the policy determines the sending rate or network congestion window at an individual flow level. To illustrate training of multiple RL agents on a shared network link, an example of network congestion control is used, as provided in FIG. 4. FIG. 4 illustrates multiple RL agents interacting in a shared network congestion control environment, in accordance with embodiments of the present disclosure. In the case of FIG. 4, the shared environment is a network link.

Referring to FIG. 4, the network link being evaluated for network congestion control includes three senders 411, 412, 413 and three receivers 421, 422, 423 on the network link. Each of the three senders 411, 412, 413 includes one or more RL agents. It should be noted that three senders 411, 412, 413 and three receivers 421, 422, 423 are provided for the purpose of illustration, and therefore there can be two senders and two receivers on the network or there can be more than three senders and more than three receivers on the network, or one or more of the senders are sending to multiple receivers or other configuration of senders and receivers as would be readily understood.

For the network congestion control, each of the senders 411, 412, 413 sends information to respective receivers 421, 422, 423. Information is sent using a stream of data, and the amount of data on the network link 430 can be measured, for example in bytes, based on the way that the information is being transmitted to the receivers 421, 422, 423.

The network link 430 can hold only a certain number of bytes (for example the threshold capacity), which is the bandwidth delay product. The agent(s) associated with each of the senders 411, 412 and 413 controls the amount of data on the network link 430 to be transmitted to the receiver(s) 421, 422, 423. Each agent controls the rate at which it adds data to the network link 430, wherein this rate is referred to as a sending rate of that agent.

If an agent adds too much data on the network link 430, the amount of data beyond a certain threshold will be held on the buffers (for example, the buffers associated with the particular network link) over the network link 430, thereby delaying the data reception by the receivers 421, 422, 423. According to embodiments, the certain threshold can define the full amount or a defined partial amount of data that the particular network link, for example network link 430, can handle at once. If the buffers associated with the network link 430 overflow, the data may be lost and may not be received. Whenever a piece of information is received, the receivers 421, 422, 423 send to the senders 411, 412, 413 acknowledgements of the receipt, respectively. Based on the time of receipt of these acknowledgements of receipt, the senders 411, 412, 413, respectively, can calculate one or more of the delivery rate (for example, the rate at which the receiver is receiving packets), the round-trip time (RTT) (for example the time elapsed from the moment a piece of information is sent until the acknowledgement of receipt is received), and the packet loss rate (for example, the ratio of the number of lost packets to the total number of packets transmitted by the sender). As the network link 430 can only handle a certain number of bytes (for example a maximum threshold), the capacity of the network link 430 needs to be fairly shared amongst the RL agents associated with the senders 421, 422, 423. In addition, in some embodiments, it can be further desired to fully utilize the network link 430 as well as to achieve a low packet loss rate and a minimum round-trip time on the network link 430.

In various embodiments, for the network congestion control, such as those illustrated in FIG. 4, an episode includes a number of steps, each of these steps lasts for double the RTT. As stated above, in this network congestion control example, the round-trip time (RTT) refers to the time elapsed between sending a packet in the data stream and receiving by the sender an acknowledgement of the receipt from the receiver. At the beginning of the step, each agent (for example, agents on the senders 411, 412, 413) determines or calculates a new sending rate based on the state of the network. During the step, the agent measures the state of the network, for example measuring the number of delivered packets, the number of lost packets and the RTT. At the end of the step, the agent creates an experience tuple including the state at the beginning of the step, the action taken during the step, the state of the network at the end of the step, and the reward obtained at the end of the step. The experience tuple of each agent is saved on a shared experience replay buffer.

According to embodiments, for the network congestion control, multiple RL agents can be deployed online (for example, agents are deployed in an online setting) and the global policy can be updated and copied to individual agents at arbitrary intervals.

After offline training, the trained global model is deployed on all senders or all agents on the senders. The senders may refer to various computing devices in the network. During the online learning phase, multiple senders may be utilized as needed, because various applications are operating using the network. Flows may arise from different applications running on a computing device and can exist on multiple network links associated with other computing devices. As such, not all of the sending agents that exist on one computing device need to share the same environment (for example, network link), as each agent can operate on different network links. However, in some embodiments, a shared experience replay buffer can exist for all agents that share the network link, for all agents that exist on a single computing device, or for all agents that exist on a cluster of computing devices. It is noted that the shared experience replay buffer may be employed on a different computing device.

In various embodiments where multiple agents are deployed online, RL agents continue to store their experience tuples on the shared experience replay buffer, wherever this shared experience replay buffer exists. Then, at arbitrary intervals, the global policy associated with each shared experience replay buffer is updated as illustrated above. It should be noted that the global model is only shared among the agents using the same shared experience replay buffer.

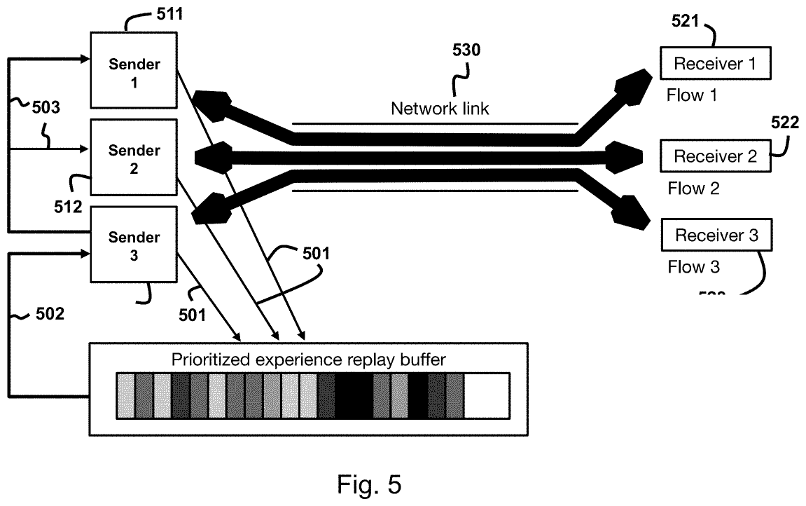

FIG. 5 illustrates an example of training multiple RL agents that are deployed online, in accordance with embodiments of the present disclosure. Referring to FIG. 5, the shared experience replay buffer 540 is shared for all agents 511, 512, 513. The agents 511, 512 and 513 use the same network link 530. The experience tuple of each agent is saved 501 in a shared experience replay buffer 540. With reference to FIG. 5, a collection of experience tuples are depicted as a the plural shaded rectangles in the shared experience replay buffer 540. The shared experience replay buffer 540 is a block of memory that stores the experience tuples. The shared experience replay buffer 540 may be configured as a prioritized experience replay buffer similar to the prioritized experience replay buffer 300 illustrated in FIG. 3. In each certain time period (for example, a pre-determined time interval), the global policy is updated. To update the global policy, a single agent (for example, agent 513) may take 502 samples of a batch of experience tuples. The sampled experience tuples can be used for updating of the global model which can be performed by the agent (for example, agent 513). Then, the updated global model will be propagated 503 to all other agents (for example, agents 511, 512) which are associated with the same network (for example, a shared environment).

It is important to note that during online learning, the agents 511, 512, 513 can decide to update their respective agent models independently. Each of the agents 511, 512, 513 independently updates their respective agent model using the experience tuples that they produced (for example, experience tuples that they saved in a non-shared experience replay buffer), instead of updating a global model using a global set of experience tuples in the shared experience replay buffer 540.

According to embodiments, including those illustrated in FIGS. 2 to 5, the fairness between multiple RL agents can be achieved without inter-agent or agent-server communication, for example by updating a global policy using experiences from all of the agents that are sharing the link. In some embodiments where multiple RL agents can be deployed online, the global model or global policy, which can be represented by a neural network, can continue to learn from exposure to new environments.

According to embodiments, multiple RL agents that share the same environment can be trained offline in a staged approach. In the staged approach, tasks progress in difficulty from stage to stage and multiple agents interact in later stages of this staged training approach. In the staged approach, a shared experience replay buffer, which may be configured as a prioritized experience replay buffer, can retain old experiences (for example old experience tuples) in addition to the newer experience tuples, such that these older experiences tuples are available for the sampling process.

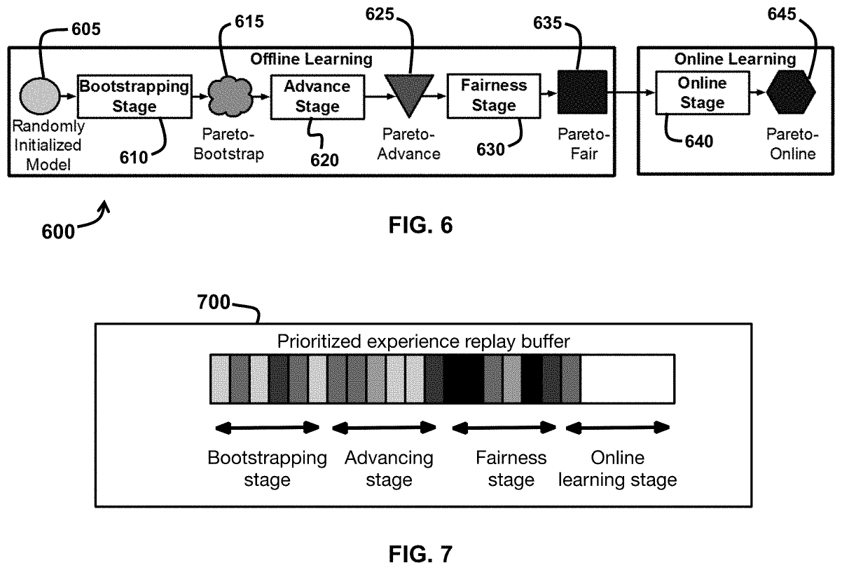

According to embodiments, a model, which can be representative of a global policy, can be trained over different stages of known episodes during offline learning. Each stage introduces a more sophisticated characteristic of the environment for which the global policy or global model is associated. For example, an initial training environment may be an environment where only one agent is present, while as training progresses through different stages, additional agents may also use the environment thus the environment becomes a shared environment. FIG. 6 illustrates an example implementation of the multi-staged process of training RL agents for network congestion control, in accordance with embodiments of the present disclosure. The multi-staged training process 600 illustrated in FIG. 6 is implemented based on the training process illustrated in FIG. 5.

The multi-staged process 600 is a new DRL-based congestion control algorithm, which may be termed as “Pareto”, which seeks to achieve (i) fairness by training to be fair to competing flows in a shared network, (ii) adaptation by learning online while remembering previously learned experiences, and (iii) generalization by learning on a wide variety of shared environments.

The multi-staged process 600 includes a bootstrapping stage 610, an advancing stage 620, a fairness training stage 630, and an online stage 640 (or online learning stage). In some embodiments, the online stage 640 may be optional. The multi-staged process 600 starts with the randomly initialized model 605, and a revised model is produced after each stage of the process 600. The revised model produced after each stage are the Pareto-Bootstrap model 615, the Pareto-Advance model 625, the Pareto-Fair model 635, and the Pareto-Online model 645, respectively.

Referring to FIG. 6, as the bootstrapping stage 610 starts, wherein the weights of the model are randomly initialized (for example, the randomly initialized model 605), hence the actions determined by the model are random at the commencement of training. To build up experience, the randomly initialized model 605 is trained in elementary (for example, easy) environments, where the bandwidth and round-trip time (RTT) are fixed and no other flow is sharing the network link. At the bootstrapping stage 610, the model's task can be configured to determine a single highest sending rate that does not build up delay or cause packet losses.

As the model converges during the bootstrapping stage 610, the training environment can be broadened and intensified to include, at the advancing stage 620, both dynamic and fixed bandwidths with fixed RTTs and unshared network links. These different environments create a new challenge for the model, as the model observes new states where the bandwidth suddenly changes, and thereby requires quick adjustment of the sending rate. At the advancing stage 620, the model's task may not be to search for the single highest sending rate. Instead, the task of the model can be to adapt to changes in bandwidth and to continuously search for the highest sending rate that does not increase delay or result in packet loss. During each of these tasks being performed by the model, the model which can be configured as a neural network, is consistently adjusting in order that the input therein aligns with the desired output. As such, updating of the model occurs during these training processes.

The final stage of offline learning is the fairness training stage 630. At the fairness training stage 630, the training environment observed by the model are further intensified by introducing a challenging environment where the bandwidth is shared by multiple flows during the fairness training stage 630. During the fairness training stage 630, the model observes one or two other flows sharing the network link. The network link has a fixed bandwidth and RTT. The new challenge to be accomplished by the model in this training stage, is for the model to provide a means for the flows to fairly share the network link with one another and to also ensure that each flow has an associated fair share of the network link. Another challenge to be accomplished by the model is to maintain the determined fairness as these flows start competing for bandwidth at different times.

The goal of the model during fairness training stage 630 is to determine the optimum sending rate in the best interest of all flows without requiring communication. By analogy, for example, the agent associated with each flow play a game together, and each agent tries to win without coalitions. At this point, no agent has an incentive to change its sending rate associated with its respective flow. Once a steady state is reached where each flow (associated with a particular agent) has a fair share of the network link without delay, for example when one agent tries to increase their sending rate beyond their fair share, such an attempt will cause a delay on the network link and all other agents will get a negative reward or penalty. If one agent decreases their sending rate below their fair share, a negative reward/penalty will be obtained by that agent as this agent decreased its associated delivery rate.

At the online learning stage 640, the model that has been trained offline is deployed as a RL agent or agent associated with one or more senders sharing the network. It is assumed that each iteration of the model, namely each RL agent or agent will observe all kinds of environments in the shared network. Hence, the agents are continually learning based on the previously observed environments, LTE networks and networks shared with a random number of senders.

The fairness training stage 630, different senders (for example RL agent) can append their experiences in the same shared experience replay buffer, for example a shared prioritized experience replay buffer. In some embodiments, in the online learning stage 640, each sender (or RL agent) has its experiences only appended to its local prioritized experience replay buffer, in order to avoid overloading the network with experience tuples from other senders. As different senders (agents) train based on their local experience tuples, their model parameters (for example the parameters associated with a neural network representing the model) may diverge from one another; however, retaining old experiences in their local experience replay buffer can prevent divergence from being disastrous.

In some embodiments, in the online learning stage 640, one or more of the senders (or RL agents) has its experiences appended to a shared experience replay buffer, which may be configured as a shared prioritized experience replay buffer.

According to some embodiments, a goal is for the model (RL agent) to learn new experiences while not forgetting old ones. It can be expected to observe improvement in performance and minimal degradation in behavior over old and new sets of environments. According to embodiments, this may be enabled by using the shared prioritized experience replay buffer produced from the fairness training stage 630 being continued to be used at the online learning stage 640. According to some embodiments, at the start of the online learning stage, the latest shared prioritized experience replay buffer is used as a starting point, however during further learning by the model (RL agent), the local prioritized experience replay buffer of each of the RL agents may diverge due to different new experiences.

According to embodiments, at each stage of offline learning, the latest 12,000 experience tuples of each stage are accumulated in the prioritized experience replay buffer (for example, prioritized experience replay buffer 700 in FIG. 7). Specifically, after offline training stages, there will be the latest 12,000 experience tuples from the bootstrapping 610, the latest 12,000 experience tuples from the advancing stage 620 and 12,000 experience tuples from the fairness training stage 630. This means that during the advancing stage 620, the model can sample a batch that has experience tuples from the bootstrapping stage 610, for example. The same also happens during the online learning stage 640, where the model can sample a batch of experience tuples from the bootstrapping stage 610, the advancing stage 620, the fairness training stage 630 along with experience tuples from the online learning stage 640. The way that a prioritized experience replay buffer 700 is segmented for the offline and online learning stages is illustrated in FIG. 7.

It is noteworthy that most of the prioritized replay buffer of all senders across the network is the same, as the starting point of the prioritized replay buffer comes after the fairness training stage 630 for all the senders (for example, the associated RL agent). Retaining old experiences in the replay buffer is essential during online learning stage 640, as it reduces the risk of model parameters of different senders diverging. Further, retaining old experiences in the experience replay buffer is also essential as various networks (for example, real-word networks) provide environments that are unpredictable, noisy and aggressive. For example, the model can observe the same environment for prolonged periods. This can raise the risk of the model overfitting, and catastrophic forgetting. By retaining old experiences gained during offline learning phase can at least in part ensure that the model would not forget old experiences and thus can avoid overfitting to one environment.

It is important to differentiate between two terms: interference and catastrophic forgetting in DRL. Interference is when there are two or more tasks that are incompatible, while catastrophic forgetting is when a model's performance degrades in one task because another task is overwriting the model's behavior. When a model is learning two destructively interfering tasks (for example, gradient updates from samples of two different tasks that are in opposite directions), the model enhances divergence or decreases at its best convergence speed. In order to alleviate the effect of conflicting gradients across different tasks, simultaneous training on destructively interfering tasks should be avoided.

The training process illustrated in the present disclosure does not provide destructively interfering models simultaneously (for example, at the same stage) during offline training stages 610 to 630. All tasks in one stage are mutually helpful as they share the same goal. Therefore, the multi-staged training is advantageous in that the destructive interference can be avoided and the convergence speed of the model can be improved.

The present disclosure provides embodiments that utilize a shared experience replay buffer to train a global/unified model in order to achieve fairness among multiple agents operating in a shared environment without inter-agent communication. The present disclosure further provides how the agents and the trained model(s) can be applied in network congestion/flow control and online training.

Embodiments of the present disclosure can be beneficial for a variety of network domains where fairness is desired among multiple agents and each agent can behave according to its own policy without needing to communicate with other agents. The method of training multiple RL agents illustrated in the present disclosure can be applied, for example, in the network flow level and network congestion control policies. The application can be extended to other policies with respect to fair/priority sharing of network resources, for example not just flow-level control, but further control at the router level or other application as would be readily understood.

In some embodiments, the methods defined in the present disclosure can be also applied for a DRL agent that controls certain transmission rates, for example, the rate at which individual applications submit work, in an oversubscribed environment where one or more resources, for example CPUs, is constrained.

In some embodiments, the methods defined in the present disclosure can be applied to speed-control of self-driving cars, for example where the policy to control speed is car-specific but learned globally.

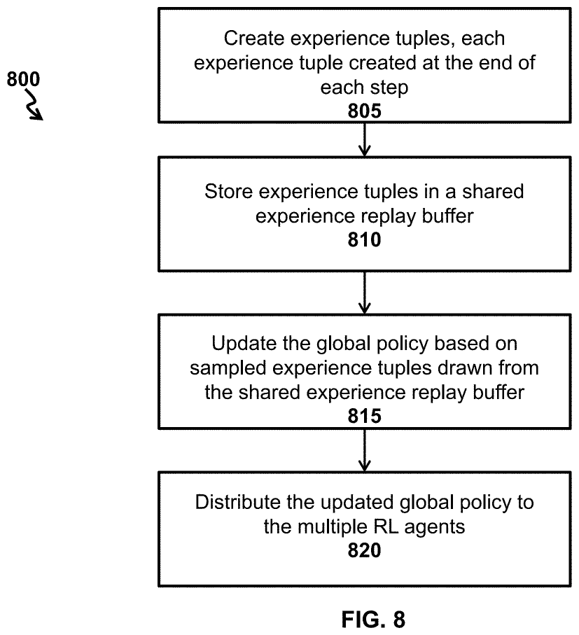

FIG. 8 illustrates a method 800 for training multiple reinforcement learning agents (RL agents), in accordance with embodiments of the present disclosure. During an episode including one or more steps and associated with the shared environment, each of the multiple RL agents behaves based at least in part on a global policy throughout the episode. The method includes creating 805, by each of the multiple RL agents, experience tuples, each experience tuple created at the end of each step and storing 810, by each of the multiple RL agents, the experience tuples in a shared experience replay buffer, the shared experience replay buffer shared by the multiple RL agents throughout the episode and a next episode. The method further includes updating 815 the global policy based on sampled experience tuples drawn from the shared experience replay buffer and distributing 820 the updated global policy to the multiple RL agents, wherein each of the multiple RL agents behave based at least in part on the updated global policy in the next episode.

In some embodiments, the updating 815 and distributing 820 is performed by one of the multiple RL agents.

In some embodiments, each experience tuple includes a state of the shared environment at the beginning of each step, an action taken during each step, a state of the shared environment at the end of each step and a reward obtained at the end of each step.

In some embodiments, the global policy is updated in a form of gradient descent such that an adjustment is made to one or more parameters of the global policy based at least in part on gradients of a loss function with respect to each of the one or more parameters.

In some embodiments, the shared experience buffer is a prioritized experience replay buffer. In some embodiments, the sampled experience tuples are drawn from the shared experience replay buffer based on unexpectedness of each experience tuple stored in the shared experience buffer, the unexpectedness of each experience tuple determined based on the global policy prior to updating. In some embodiments, the multiple RL agents are trained using a multi-staged process, the multi-staged process progressing in difficulty from stage to stage, each stage adding a challenging characteristic associated with the shared environment. In some embodiments, the shared experience replay buffer is divided into multiple segments, each segment associated with each stage of the multi-staged process. In some embodiments, the multi-staged process includes a bootstrapping stage, an advancing stage, a fairness training stage. In some embodiments, the multi-staged process further includes an online stage.

In some embodiments, the multiple RL agents are deployed online and the updated global policy is distributed to the multiple RL agents at arbitrary intervals.

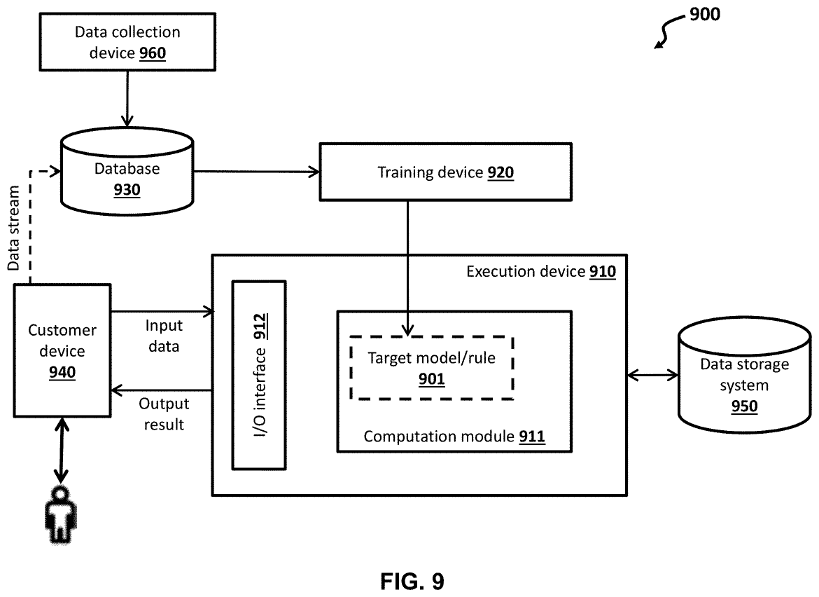

FIG. 9 is a schematic structural diagram of a system architecture 900 according to an embodiment of the present disclosure. A data collection device 960 is configured to collect various data (for example, data obtained from the environment 120) and store the collected data into a database 930. A training device 900 may generate a target model/rule 901 based on the data maintained in the database 930.

Work at each layer of a deep neural network may be described by using a mathematical expression \vec{y}=a(W□\vec{x}+b): From a physical perspective, the work at each layer of the deep neural network can be understood as performing five operations on input space (a set of input vectors), to complete a conversion from the input space into output space (in other words, from row space to column space of a matrix). The five operations include: 1. Dimensionality increase/reduction; 2. zooming in/out; 3. rotation; 4. panning; and 5. “bending”. The operations 1, 2, and 3 are performed by W□\vec{x}, the operation 4 is performed by +b, and the operation 5 is implemented by a( ) Herein, a reason why the word “space” is used for description is that objects to be classified are not single matters, but are a type of matters. The space indicates a set of all individuals in this type of matters. W denotes a weight vector. Each value in the vector indicates a weight value of one neural cell at the layer of neural network. The vector W decides the foregoing spatial conversion from the input space to the output space. In other words, the weight W of each layer controls how to convert space. A purpose of training the deep neural network is to finally obtain a weight matrix (a weight matrix consisting of vectors W of a plurality of layers) of all layers of the trained neural network. Therefore, in essence, the training process of the neural network is learning a manner of controlling spatial conversion, and more specifically, learning a weight matrix.

To enable the deep neural network to output a predicted value that is as close to a truly desired value as possible, a predicted value of a current network and a truly desired target value may be compared, and a weight vector of each layer of the neural network is updated based on a difference between the predicted value and the truly desired target value (Certainly, there is usually an initialization process before a first update and to be specific, a parameter is preconfigured for each layer of the deep neural network). For example, if the predicted value of a network is excessively high, continuously adjust a weight vector to lower the predicted value, until the neural network can predict the truly desired target value. Therefore, “how to compare a difference between a predicted value and a target value” needs to be predefined. To be specific, a loss function (loss function) or an objective function (objective function) needs to be predefined. The loss function and the objective function are important equations used to measure the difference between a predicted value and a target value. For example, the loss function is used as an example. A higher output value (loss) of the loss function indicates a greater difference. In this case, training the deep neural network is a process of minimizing the loss.

The target module/rule (for example, desired policy) obtained by the training device 920 may be applied to different systems or devices. In FIG. 9, an execution device 910 is provided with an I/O interface 912 to perform data interaction with an external device. A “user” may input data to the I/O interface 912 by using a customer device 940.

The execution device 910 may refer to a device containing the agents (for example, senders 411, 412, 413, 511, 512, 513 containing the RL agents) having applied the embodiments described herein, for example, the embodiments described in FIGS. 2 and 4 to 6. The execution device 910 may invoke data, code, and the like from a data storage system 950, and may store the data, an instruction, and the like into the data storage system 950.

A computation module 911 processes the input data by using the target model/rule 901. Finally, the I/O interface 912 returns a processing result to the customer device 940 and provides the processing result to the user. More deeply, the training device 920 may generate corresponding target models/rules 901 for different targets based on different data, to provide a better result for the user.

In a case shown in FIG. 9, the user may manually specify data to be input to the execution device 910, for example, an operation in a screen provided by the I/O interface 912. In another case, the customer device 940 may automatically input data to the I/O interface 912 and obtain a result. If the customer device 940 automatically inputs data, authorization of the user needs to be obtained. The user can specify a corresponding permission in the customer device 940. The user may view, in the customer device 940, the result output by the execution device 910. A specific presentation form may be display content, a voice, an action, and the like. In addition, the customer device 940 may be used as a data collector to store collected data into the database 930.

It should be noted that FIG. 9 is merely a schematic diagram of a system architecture according to an embodiment of the present disclosure. Position relationships between the device, the component, the module, and the like that are shown in FIG. 9 do not constitute any limitation. For example, in FIG. 9, the data storage system 950 is an external memory relative to the execution device 910. In another case, the data storage system 950 may be located in the execution device 910.

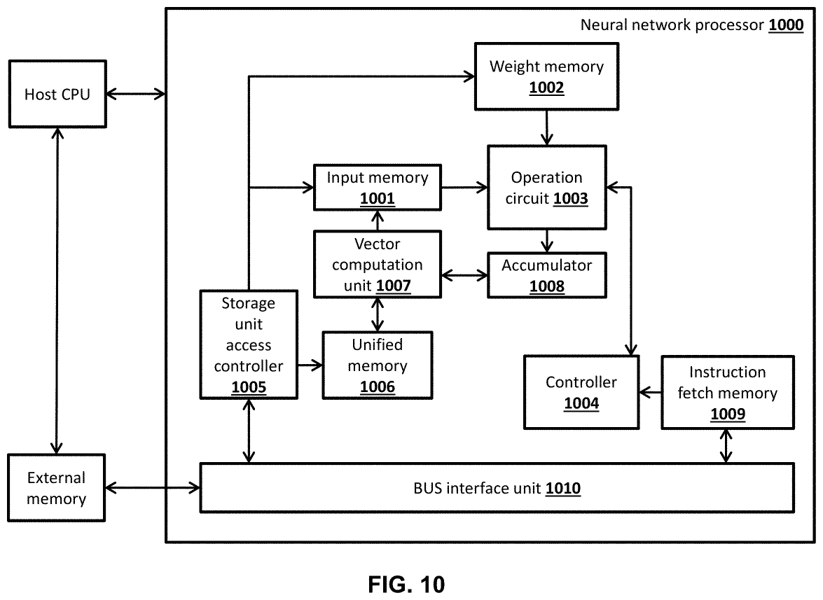

FIG. 10 is a structural hardware diagram of a chip according to an embodiment of the present disclosure. The chip includes a neural network processor 1000. The chip may be provided in the execution device 910 shown in FIG. 9, to perform computation for the computation module 911. Alternatively, the chip may be provided in the training device 920 shown in FIG. 9, to perform training and output the target model/rule 901.

The neural network processor 1000 may be any processor that is applicable to massive exclusive OR operations, for example, a neural processing unit (NPU), a tensor processing unit (TPU), a graphics processing unit (GPU), or the like. The NPU is used as an example. The NPU may be mounted, as a coprocessor, to a host CPU (host CPU), and the host CPU allocates a task. A core part of the NPU is an operation circuit 1003. A controller 1004 controls the operation circuit 1003 to extract matrix data from a memory and perform a multiplication operation.

In some implementations, the operation circuit 1003 internally includes a plurality of processing units (process engine, PE). In some implementations, the operation circuit 1003 is a bi-dimensional systolic array. In addition, the operation circuit 1003 may be a uni-dimensional systolic array or another electronic circuit that can implement a mathematical operation such as multiplication and addition. In some implementations, the operation circuit 1003 is a general matrix processor.

For example, it is assumed that there are an input matrix A, a weight matrix B, and an output matrix C. The operation circuit obtains, from a weight memory 1002, data corresponding to the matrix B, and caches the data in each PE in the operation circuit. The operation circuit obtains data of the matrix A from an input memory 1001, and performs a matrix operation on the data of the matrix A and the data of the matrix B. An obtained partial or final matrix result is stored in an accumulator (accumulator) 1008.

A unified memory 1006 is configured to store input data and output data. Weight data is directly moved to the weight memory 1002 by using a storage unit access controller (for example, direct memory access controller, DMAC) 1005. The input data is also moved to the unified memory 1006 by using the DMAC.

An interface unit (BIU) 1010 is configured to enable an AXI bus to interact with the DMAC and an instruction fetch memory (instruction fetch buffer) 1009. The BIU 1010 may be further configured to enable the instruction fetch memory 1009 to obtain an instruction from an external memory, and is further configured to enable the storage unit access controller 1005 to obtain, from the external memory, source data of the input matrix A or the weight matrix B.

The storage unit access controller (for example, DMAC) 1005 is mainly configured to move input data from an external memory DDR to the unified memory 1006, or move the weight data to the weight memory 1002, or move the input data to the input memory 1001.

A vector computation unit 1007 includes a plurality of operation processing units. If needed, the vector computation unit 1007 performs further processing, for example, vector multiplication, vector addition, an exponent operation, a logarithm operation, or magnitude comparison, on an output from the operation circuit. The vector computation unit 1007 is mainly used for non-convolutional/FC-layer network computation in a neural network, for example, pooling (pooling), batch normalization (batch normalization), or local response normalization (local response normalization).

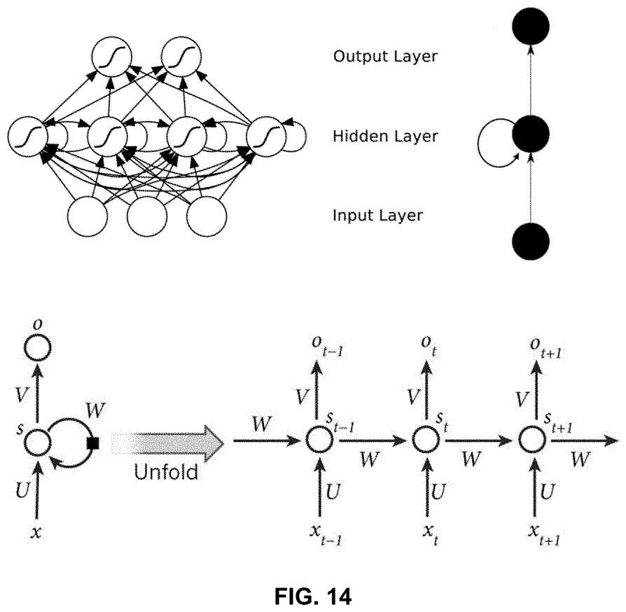

In some implementations, the vector computation unit 1007 can store, to the unified buffer 1006, a vector output through processing. For example, the vector computation unit 1007 may apply a nonlinear function to an output of the operation circuit 1003, for example, a vector of an accumulated value, to generate an activation value. In some implementations, the vector computation unit 1007 generates a normalized value, a combined value, or both a normalized value and a combined value. In some implementations, the vector output through processing (the vector processed by the vector computation unit 1007) may be used as activation input to the operation circuit 1003, for example, to be used in some layer(s) of the recurrent neural network in FIG. 14.

The instruction fetch memory (instruction fetch buffer) 1009 connected to the controller 1004 is configured to store an instruction used by the controller 1004. The unified memory 1006, the input memory 1001, the weight memory 1002, and the instruction fetch memory 1009 are all on-chip memories. The external memory is independent from the hardware architecture of the NPU.

Operations at the layers of the recurrent neural networks, for example RNN shown in FIG. 14 may be performed by the operation circuit 1003 or the vector computation unit 1007.

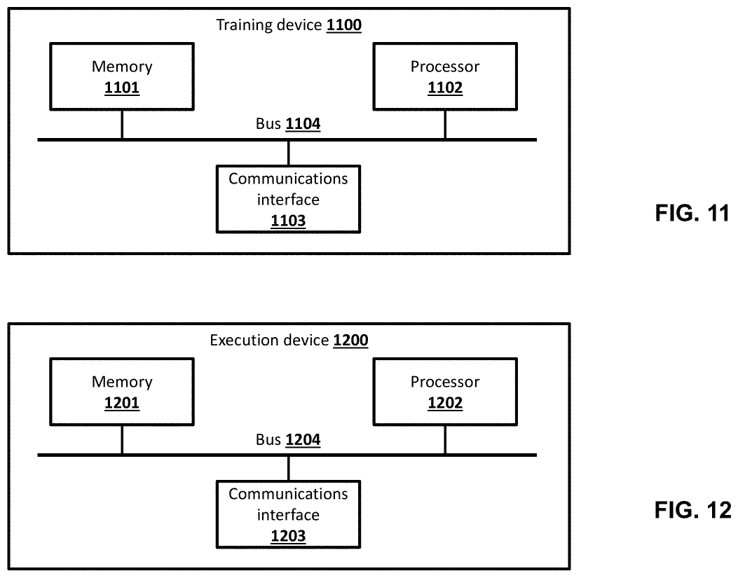

FIG. 11 is a schematic diagram of a hardware structure of a training apparatus according to an embodiment of the present disclosure. A training apparatus 1100 shown in FIG. 11 includes a memory 1101, a processor 1102, a communications interface 1103, and a bus 1104. A communication connection is implemented between the memory 1101, the processor 1102, and the communications interface 1103 by using the bus 1104. The apparatus 1100 may be specifically a computer device and may refer to the training device 920.

The memory 1101 may be a read-only memory (read only memory, ROM), a static storage device, a dynamic storage device, or a random access memory (random access memory, RAM). The memory 1101 may store a program. The processor 1102 and the communications interface 1103 are configured to perform, when the program stored in the memory 1101 is executed by the processor 1102, steps of one or more embodiments described herein, for example, embodiments described in reference to FIGS. 2 and 4 to 6.

The processor 1102 may be a general central processing unit (central processing unit, CPU), a microprocessor, an application-specific integrated circuit (application specific integrated circuit, ASIC), a graphics processing unit (graphics processing unit, GPU), or one or more integrated circuits. The processor 1102 may be configured to execute a related program to implement a function that needs to be performed by a unit in the training apparatus according to one or more embodiments described herein, for example, embodiments described in reference to FIGS. 2 and 4 to 6.

In addition, the processor 1102 may be an integrated circuit chip with a signal processing capability. In an implementation process, steps of the training method in the network according to this application may be performed by an integrated logical circuit in a form of hardware or by an instruction in a form of software in the processor 1102. In addition, the foregoing processor 1102 may be a general purpose processor, a digital signal processor (digital signal processor, DSP), an application-specific integrated circuit (ASIC), a field programmable gate array (field programmable gate array, FPGA) or another programmable logic device, a discrete gate or a transistor logic device, or a discrete hardware assembly. The processor 1102 may implement or execute the methods, steps, and logical block diagrams that are disclosed in the embodiments of this application. The general purpose processor may be a microprocessor, or the processor may be any conventional processor or the like. The steps of the method disclosed with reference to the embodiments of this application may be directly performed by a hardware decoding processor, or may be performed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory 1101. The processor 1102 reads information from the memory 1101, and completes, by using hardware in the processor 1102, the functions that need to be performed by the units included in the training apparatus in the network according to one or more embodiments described herein, for example, embodiments described in reference to FIGS. 2 and 4 to 6.

The communications interface 1103 implements communication between the apparatus 1100 and another device or communications network by using a transceiver apparatus, for example, including but not limited to a transceiver. For example, training data may be obtained by using the communications interface 1103.

The bus 1104 may include a path that transfers information between all the components (for example, the memory 1101, the processor 1102, and the communications interface 1103) of the apparatus 1100.

FIG. 12 is a schematic diagram of a hardware structure of an execution apparatus according to an embodiment of the present disclosure. An execution apparatus 1200 shown in FIG. 12 includes a memory 1201, a processor 1202, a communications interface 1203, and a bus 1204. A communication connection is implemented between the memory 1201, the processor 1202, and the communications interface 1203 by using the bus 1204. The apparatus 1200 may be specifically a computer device or refer to the execution device 910 or devices containing the agents (for example, senders 411, 412, 413, 511, 512, 513 containing the RL agents).

The memory 1201 may be a read-only memory (read only memory, ROM), a static storage device, a dynamic storage device, or a random access memory (random access memory, RAM). The memory 1201 may store a program. The processor 1201 and the communications interface 1202 are configured to perform, when the program stored in the memory 1202 is executed by the processor 1203, steps of one or more embodiments described herein, for example, embodiments described in reference to FIGS. 2 and 4 to 6.

The processor 1202 may be a general central processing unit (central processing unit, CPU), a microprocessor, an application-specific integrated circuit (application specific integrated circuit, ASIC), a graphics processing unit (graphics processing unit, GPU), or one or more integrated circuits. The processor 1202 may be configured to execute a related program to implement a function that needs to be performed by a unit in the execution apparatus according to one or more embodiments described herein, for example, embodiments described in reference to FIGS. 2 and 4 to 6.

In addition, the processor 1202 may be an integrated circuit chip with a signal processing capability. In an implementation process, steps of one or more execution methods described in the present disclosure may be performed by an integrated logical circuit in a form of hardware or by an instruction in a form of software in the processor 1202. In addition, the foregoing processor 1202 may be a general purpose processor, a digital signal processor (digital signal processor, DSP), an application-specific integrated circuit (ASIC), a field programmable gate array (field programmable gate array, FPGA) or another programmable logic device, a discrete gate or a transistor logic device, or a discrete hardware assembly. The foregoing processor 1202 may implement or execute the methods, steps, and logical block diagrams that are disclosed in the embodiments of this application. The general purpose processor may be a microprocessor, or the processor may be any conventional processor or the like. The steps of the method disclosed with reference to the embodiments of this application may be directly performed by a hardware decoding processor, or may be performed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory 1201. The processor 1202 reads information from the memory 1201, and completes, by using hardware in the processor 1202, the functions that need to be performed by the units included in the execution apparatus according to one or more embodiments described herein, for example, embodiments described in reference to FIGS. 2 and 4 to 6.

The communications interface 1203 implements communication between the apparatus 1200 and another device or communications network by using a transceiver apparatus, for example, including but not limited to a transceiver. For example, training data to protect the DRL agent may be obtained by using the communications interface 1203.

The bus 1204 may include a path that transfers information between all the components (for example, the memory 1201, the processor 1202, and the communications interface 1203) of the apparatus 1200.

It should be noted that, although only the memory, the processor, and the communications interface are shown in the apparatuses 1100 and 1200 in FIG. 11 and FIG. 12, in a specific implementation process, a person skilled in the art should understand that the apparatuses 1100 and 1200 may further include other components that are necessary for implementing normal running. In addition, based on specific needs, a person skilled in the art should understand that the apparatuses 1100 and 1200 may further include hardware components that implement other additional functions. In addition, a person skilled in the art should understand that the apparatuses 1100 and 1200 may include only a component required for implementing the embodiments of the present disclosure, without a need to include all the components shown in FIG. 11 or FIG. 12.

It may be understood that the apparatus 1100 is equivalent to the training device 900 in FIG. 9, and the apparatus 1200 is equivalent to the execution device 910 in FIG. 9. A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

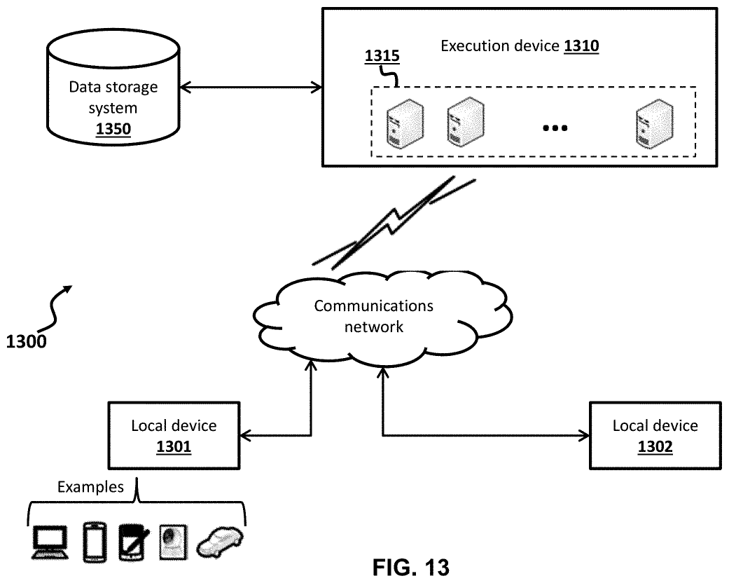

FIG. 13 illustrates a system architecture 1300 according to an embodiment of the present disclosure. Referring to FIG. 13, an embodiment of the present disclosure provides a system architecture 1300. An execution device 1310 is implemented by one or more servers 1315, and optionally, supported by another computation device, for example, a data memory, a router, a load balancer, or another device. The execution device 1310 may be arranged in a physical station or be distributed to a plurality of physical stations. The execution device 1310 may use data in a data storage system 1350 or invoke program code in a data storage system 1350, to implement steps of the method disclosed with reference to the embodiments of this application

Users may operate respective user equipment (such as a local device 1301 and another local device 1302) of the users to interact with the execution device 1310. Each local device may indicate any computation device, for example, a personal computer, a computer work station, a smartphone, a tablet computer, a smart camera, a smart car, or another type of cellular phone, a media consumption device, a wearable device, a set-top box, or a game console.

The local device of each user may interact with the execution device 1310 by using a communications network of any communications mechanism/communications standard. The communications network may be a wide area network, a local area network, a point-to-point connected network, or any combination thereof.

In another implementation, one or more aspects of the execution devices 1310 may be implemented by each local device. For example, the local device 1301 may provide local data for the execution device 1310 or feed back a computation result.

It should be noted that all functionalities of the execution device 1310 may be implemented by the local device. For example, the local device 1301 implements a function of the execution device 1310 and provides a service for a user of the local device 1301, or provides a service for a user of the local device 1302.

FIG. 14 is a schematic structural diagram of an RNN according to embodiments of the present disclosure. RNNs are to process sequence data. In a conventional neural network model, a full connection is implemented between layers, from an input layer to a hidden layer and then to an output layer, and nodes between layers are disconnected. However, such a common neural network is incapable of resolving many problems. For example, to predict a word in a sentence, a previous word is usually needed, because a word is dependent on its previous word in a sentence. RNNs are referred to as recurrent neural networks, because a current output of a sequence is also related to a previous output. In a specific representation form, a network memorizes previous information and applies the previous information to computation of the current output. In other words, the nodes between the hidden layers are no longer disconnected, but are connected, and an input to a hidden layer not only includes an output from the input layer, but also includes an output from the hidden layer at a previous moment. In theory, the RNNs can process sequence data of any length.

Training of the RNN is the same as training of a conventional ANN (artificial neural network). The BP error back propagation algorithm is also used. However, there is a difference. If the RNNs are unfolded, parameters W, U, and V are shared. However, the parameters are not shared in a conventional neural network. In addition, in a gradient descent algorithm, an output of each step not only depends on a network of a current step, but also depends on network states of several previous steps. For example, when t is 4, the propagation needs to be performed backward for three additional steps, and respective gradients need to be added to each of the three steps. The learning algorithm is referred to as back propagation through time (back propagation through time, BPTT).

The recurrent neural network is needed in spite of the existing artificial neural network and the existing convolutional neural network. A premise of the convolutional neural network and a premise of the artificial neural network are both as follows: Elements are mutually independent, and an input is independent from an output. However, in the real world, many elements are mutually connected, and inputs are often affected by outputs. Therefore, to overcome the gap between the real world and the premise of existing convolutional neural network and artificial neural network, the present recurrent neural network emerges. The essence of the recurrent neural network is that the recurrent neural network has a memorizing capability, just like a human being does. In this way, an output of the recurrent neural network depends on a current input and a memory.

Referring to FIG. 14 illustrating a structure of an RNN, each circle may be considered as one cell, and each cell does a same thing. Therefore, the diagram may be folded into a half figure on the left. In a word, the RNN is obtained through repeated use of one cell structure.

The sequence-to-sequence model has an RNN. It is assumed that xₜ₋₁, xₜ, and xₜ₊₁ are inputs: “United States of”. In this case, oₜ₋₁ and oₜ are corresponding to “States” and “of” respectively. Upon prediction of the next word, there is a relatively high probability that oₜ₊₁ is “America”.

Therefore, the followings can be defined:
Xₜ indicates an input at a t moment, oₜ indicates an output at the t moment, and Sₜ indicates a memory at the t moment. An output at a current moment is determined based on an output at the current moment and a memory. A neural network is best at integrating a large amount of content by using a series of parameters and then learning the parameters. In this way, a base of the RNN is defined as follows:

Sₜ=f(U*Xₜ+W*Sₜ₋₁)

The f( ) function is an activation function in the neural network. Since the RNN is capable of memorizing, certainly, only important information is memorized, other unimportant information can be surely forgotten. For that, an activation function is needed for filtering information in the neural network. Therefore, an activation function is applied herein, to make a non-linear mapping to filter information. This activation function may be tan h or may be another function.

An idea of the RNN is to make a prediction based on the memory Sₜ at the current moment. When a next word for “United States of” is predicted, it is apparent that the next word would be “America”. In practice, such predictions will be made using softmax to ensure the next word is most appropriate and probable word to be placed. However, it should be noted that as a matrix cannot be directly used to make such prediction, a weight matrix V needs to be utilized when making the prediction. The weight matrix is indicated by the following formula:

oₜ=softmax (V Sₜ), where o_{f} indicates the output at the t moment.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the disclosure are examples and can be varied in many ways. Such present or future variations are not to be regarded as a departure from the spirit and scope of the disclosure, and all such modifications as would be obvious to one skilled in the art are intended to be included within the scope of the following claims.

We claim:

1. A method for training multiple reinforcement learning (RL) agents deployed in a shared environment, the method comprising:
during an episode including one or more steps and associated with the shared environment, each of the multiple RL agents behaving based at least in part on a global policy throughout the episode; the method comprising:
creating, by each of the multiple RL agents, experience tuples, each experience tuple created at the end of each step; and
storing, by each of the multiple RL agents, the experience tuples in a shared experience replay buffer, the shared experience replay buffer shared by the multiple RL agents throughout the episode and a next episode;
wherein after the episode the method further includes:
updating the global policy based on sampled experience tuples drawn from the shared experience replay buffer, and
distributing the updated global policy to the multiple RL agents, wherein each of the multiple RL agents behave based at least in part on the updated global policy in the next episode.

2. The method of claim 1, wherein updating and distributing are performed by one of the multiple RL agents.

3. The method of claim 1, wherein each experience tuple includes a state of the shared environment at the beginning of each step, an action taken during each step, a state of the shared environment at the end of each step and a reward obtained at the end of each step.

4. The method of claim 1, wherein the global policy is updated in a form of gradient descent such that an adjustment is made to one or more parameters of the global policy based at least in part on gradients of a loss function with respect to each of the one or more parameters.

5. The method of claim 1, wherein the shared experience buffer is a prioritized experience replay buffer.

6. The method of claim 5, wherein the sampled experience tuples are drawn from the shared experience replay buffer based on unexpectedness of each experience tuple stored in the shared experience buffer, the unexpectedness of each experience tuple determined based on the global policy prior to updating.

7. The method of claim 5, wherein the multiple RL agents are trained using a multi-staged process, the multi-staged process progressing in difficulty from stage to stage, each stage adding a challenging characteristic associated with the shared environment.

8. The method of claim 7, wherein the shared experience replay buffer is divided into multiple segments, each segment associated with each stage of the multi-staged process.

9. The method of claim 7, wherein the multi-staged process includes a bootstrapping stage, an advancing stage, a fairness training stage.

10. The method of claim 8, wherein the multi-staged process further includes an online stage.

11. The method of claim 1, wherein the multiple RL agents are deployed online and the updated global policy is distributed to the multiple RL agents at arbitrary intervals.

12. A system for training multiple reinforcement learning (RL) agents deployed in a shared environment, during an episode including one or more steps and associated with the shared environment, each of the multiple RL agents behaving based at least in part on a global policy throughout the episode, the system comprising:
a data collection unit associated with the multiple RL agents, the data collection unit having a processor and a memory storing instructions, the instructions when executed by the processor configure the data collection unit to:
receive from each of the multiple RL agents, experience tuples, each experience tuple created at the end of each step; and
store the experience tuples in a shared experience replay buffer, the shared experience replay buffer shared by the multiple RL agents throughout the episode and a next episode; and
a training unit associated with the multiple RL agents, the training unit having a processor and a memory storing instructions, the instructions when executed by the processor configure the training unit, after each episode, to:
update the global policy based on sampled experience tuples drawn from the shared experience replay buffer, and
distribute the updated global policy to the multiple RL agents, wherein each of the multiple RL agents behave based at least in part on the updated global policy in the next episode.

13. The system of claim 12, wherein updating and distributing are performed by one of the multiple RL agents.

14. The system of claim 12, wherein each experience tuple includes a state of the shared environment at the beginning of each step, an action taken during each step, a state of the shared environment at the end of each step and a reward obtained at the end of each step.

15. The system of claim 12, wherein the global policy is updated in a form of gradient descent such that an adjustment is made to one or more parameters of the global policy based at least in part on gradients of a loss function with respect to each of the one or more parameters.

16. The system of claim 12, wherein the shared experience buffer is a prioritized experience replay buffer.

17. The system of claim 16, wherein the sampled experience tuples are drawn from the shared experience replay buffer based on unexpectedness of each experience tuple stored in the shared experience buffer, the unexpectedness of each experience tuple determined based on the global policy prior to updating.

18. The system of claim 16, wherein the multiple RL agents are trained using a multi-staged process, the multi-staged process progressing in difficulty from stage to stage, each stage adding a challenging characteristic associated with the shared environment.

19. The system of claim 18, wherein the shared experience replay buffer is divided into multiple segments, each segment associated with each stage of the multi-staged process, and wherein the multi-staged process includes a bootstrapping stage, an advancing stage, and a fairness training stage.

20. The system of claim 19, wherein the multi-staged process further includes an online stage.
